(19) United States
(12) Patent Application Publication
(10) Pub. No.: US 2020/0042305 A1
(43) Pub. Date: Feb. 6, 2020

(54) SYSTEM AND METHOD FOR SECURE PEER DEPLOYMENT OF SOFTWARE TO NETWORKED DEVICES

(71) Applicant: Toshiba TEC Kabushiki Kaisha, Shinagawa-ku (JP)

(72) Inventors: William SU, Riverside, CA (US); Jia ZHANG, Irvine, CA (US)

(21) Appl. No.: 16/527,869

(22) Filed: Jul. 31, 2019

Related U.S. Application Data
(60) Provisional application No. 62/712,616, filed on Jul. 31, 2018.

(51) Int. Cl. G06F 8/65; G06F 9/445; G06F 9/451; G06F 21/57

(52) U.S. Cl. CPC G06F 8/65; G06F 9/44589; G06F 2221/033; G06F 21/57; G06F 9/451

(57) ABSTRACT

A system and method for secure, peer-based validation, distribution and installation of software includes two or more networked multifunction peripheral devices, each of which stores a common blockchain ledger. A blockchain transaction block is created and distributed among the devices. The block includes software comprising a single package that includes software for device installation or configuration, along with a smart contract. When the devices validate the block by consensus, it is added to the blockchain and each device executes the smart contract and installs or configures itself in accordance with the software when the smart contract determines that the software is appropriate for the device.

### CROSS-REFERENCE TO RELATED APPLICATIONS

This application claims the benefit of U.S. Provisional Application No. 62/712,616 filed Jul. 31, 2018, which is incorporated herein by reference.

### TECHNICAL FIELD

This application relates generally to distributing software to networked devices. The application relates more particularly to peer device secure deployment, validation and selective installation of software, such as software specifying device configurations or software updates.

### BACKGROUND

Document processing devices include printers, copiers, scanners and e-mail gateways. More recently, devices employing two or more of these functions are found in office environments. These devices are referred to as multifunction peripherals (MFPs) or multifunction devices (MFDs). As used herein, MFPs are understood to comprise printers, alone or in combination with other of the afore-noted functions. It is further understood that any suitable document processing device can be used.

MFPs are complex devices that require regular maintenance and configuration. It is costly and time consuming to service or configure a large number of MFPs, one at a time.

### BRIEF DESCRIPTION OF THE DRAWINGS

Various embodiments will become better understood with regard to the following description, appended claims and accompanying drawings wherein:

FIG. 1 is an example embodiment of a peer-based secure software delivery and installation system;

FIG. 2 is an example embodiment of a networked digital device comprising a multifunction peripheral;

FIG. 3 is an example embodiment of showing a one-to-one and a peer-based software distribution system;

FIG. 4 is an example embodiment of a system for distributing and installing software comprising a single package;

FIG. 5 is a flowchart of an example embodiment of generation and broadcasting of software, such as a single package; and

FIG. 6 is a flowchart of an example embodiment of a system for receiving, validating and installing software in accordance with a blockchain.

### DETAILED DESCRIPTION

The systems and methods disclosed herein are described in detail by way of examples and with reference to the figures. It will be appreciated that modifications to disclosed and described examples, arrangements, configurations, components, elements, apparatuses, devices methods, systems, etc. can suitably be made and may be desired for a specific application. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such.

As noted above, it is costly and time consuming to configure or maintain MFPs individually. Modern MFPs are run by integrated computer systems, referred to as controllers. MFPs are typically connected to a network to allow for shared use, such as networked printing and email communication. Remote configuration or updating of MFPs may be done via a network connection. However, each device is still individually contacted and updated or configured.

MFPs include user interfaces, such as touchscreens for user operation and control. A typical user interface is set by a manufacturer and not subject to user modification. More recent advances allow end users to generate customized device interfaces that may be specific to their needs, such as by providing access to frequently needed functions for easy location and selection. Different business types may have different basic device needs. MFPs in a hospital may require ready access to electronic health records, insurance forms, prescription forms, patient questionnaires, and the like. MFPs in hospitals may also require enhanced security features, such as encryption or disabling or limiting information reproduction or transfer to maintain patient confidentiality. MFPs in law office may require ready access to legal forms, and be configured to generate bound material, such as printouts of deposition transcripts. A company may also wish to configure a user interface to incorporate a company logo, such as in a user interface background.

When a specific business, or business location, wishes to have a uniform, customized interface on its many MFPs, it can be extremely time consuming and costly to supply software to update, customize or configure them individually. Software comprising a portable configuration file allows for creation of a customized interface by uploading it into all devices. However, certain devices may be from a different manufacturer, different model or different firmware version rendering them incompatible with a distributed software/configuration file. In such instances, installation of software or a configuration file on incompatible devices can damage the devices or render some or all features unusable. Also, attempted installation of corrupt software places all devices at risk. Also, interfaces that are customized for a particular business should be installed only on its MFPs.

Example embodiments herein provide a secure, peer-based software distribution with automated verification, compatibility testing and installation. Software, such as device software or configuration information, is stored and distributed as a block in a blockchain that is distributed among networked MFPs.

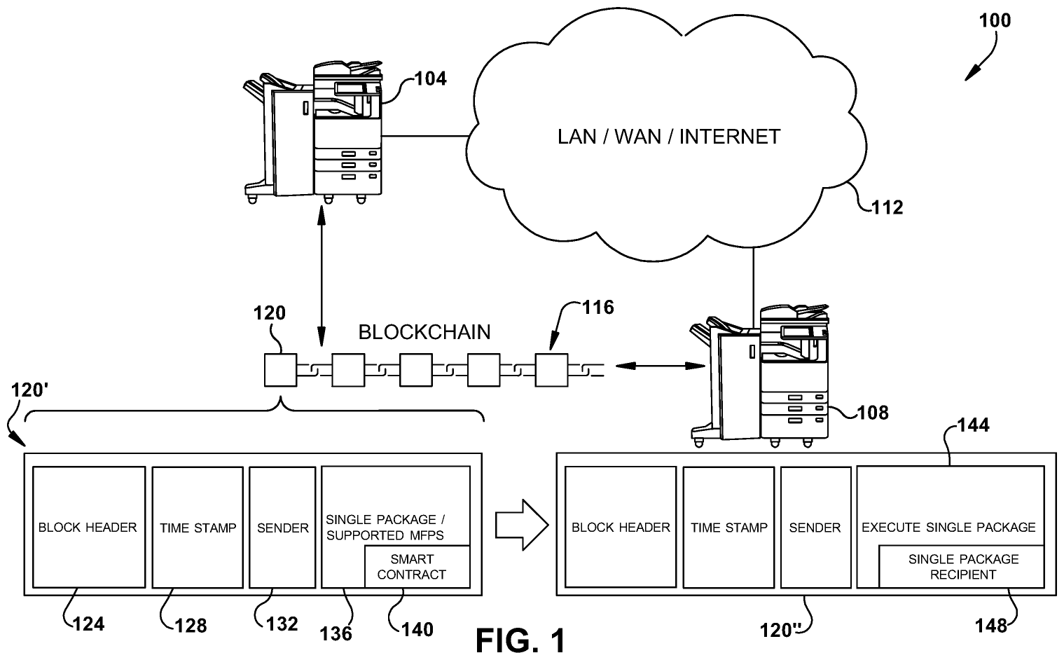

In accordance with the subject application, FIG. 1 illustrates an example embodiment of a peer-based secure software delivery and installation system 100 that includes two or more MFPs, illustrated by way of example by MFPs 104 and 108. MFPs 104 and 108 are in network communication with network cloud 112, suitably comprised of any wireless or wired local area network (LAN) or a wide area network (WAN) which can comprise the Internet, or any suitable combination thereof. MFPs 104 and 108 are intelligent devices including an embedded computer, referred to as a controller. A distributed ledger system between MFPs is comprised of blockchain 116. An example block 120 of blockchain 116, illustrated as expanded block 120′, includes data comprising block header 124, time stamp 128, sender identification information 132, and a software module 136. Software module 136, referred to as single package, includes software comprising an installation package comprising software for installation, along with software identifying MFPs that are supported for installation of the software. Software module 136 also includes software comprising a smart contract 140 that is executed after a block has been received and verified at an MFP. The smart contract 140 determines if the MFP on which the block resides is compatible with the installation software. If so, the software, such updated or revised device software or configuration software, is installed as illustrated by block 120″ wherein the single package is executed at block 144 to a recipient identified in block 148.

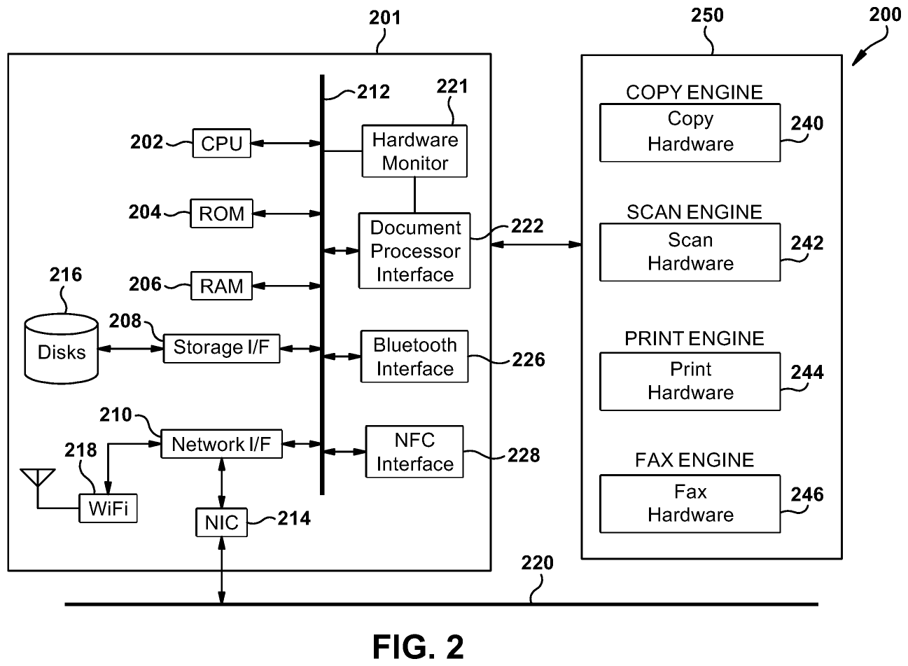

Turning now to FIG. 2 illustrated is an example embodiment of a networked digital device comprised of document rendering system 200 suitably comprised within an MFP, such as with MFPs 104 or 108 of FIG. 1. As noted above, an MFP includes an intelligent controller 201 which is itself a computer system. Included in controller 201 are one or more processors, such as that illustrated by processor 202. Each processor is suitably associated with non-volatile memory, such as read only memory (ROM) 204, and random access memory (RAM) 206, via a data bus 212.

Processor 202 is also in data communication with a storage interface 208 for reading or writing data with storage 216, suitably comprised of a hard disk, optical disk, solid-state disk, cloud-based storage, or any other suitable data storage as will be appreciated by one of ordinary skill in the art.

Processor 202 is also in data communication with a network interface 210 which provides an interface to a network interface controller (NIC) 214, which in turn provides a data path to any suitable wired or physical network connection 220, or to a wireless data connection via a wireless network interface, such as WiFi 218. Example wireless connections include cellular, Wi-Fi, wireless universal serial bus (wireless USB), satellite, and the like. Example wired interfaces include Ethernet, USB, IEEE 1394 (FireWire), Lightning, telephone line, or the like. Processor 202 is also in data communication with a hardware monitor 221, suitably amassing state data from subassemblies, sensors, digital thermometers, or the like, and suitably including digital state date including device codes, such as device error codes. Processor 202 can also be in data communication a document processor interface 222, with BLUETOOTH interface 226 and NFC interface 228 via data path 212.

Processor 202 can also be in data communication with any suitable user input/output (I/O) interface (not shown) which provides data communication with user peripherals, such as displays, keyboards, mice, track balls, touch screens, or the like.

Document processor interface 222 is suitable for data communication with MFP functional units 250. In the illustrate example, these units include a copy engine, suitably comprised of copy hardware 240, a scan engine, suitably comprised of scan hardware 242, a print engine, suitably comprised of print hardware 244 and a fax engine, suitably comprised of fax hardware 246. These subsystems together comprise MFP functional hardware 250. It will be understood that functional units are suitably comprised of intelligent units, including any suitable hardware or software platform.

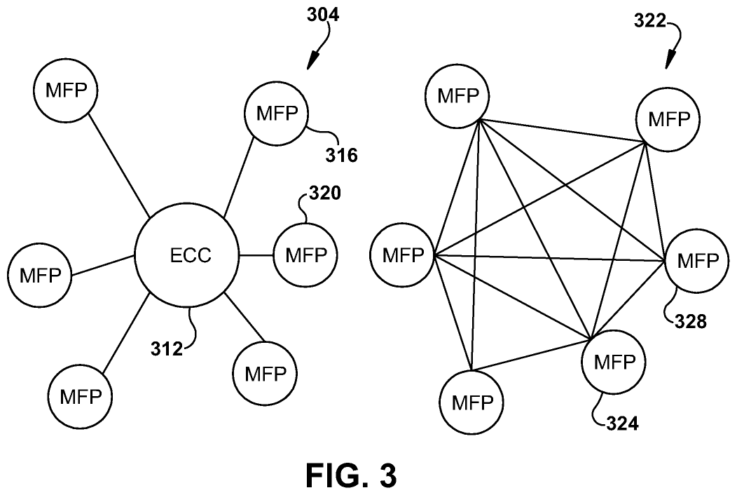

FIG. 3 illustrates a comparison between a one-to-one software system 304 and a peer-based software distribution and verification system 322. A one-to-one software system 304, such as Toshiba's e-BRIDGE CloudConnect, is illustrated at ECC module 312 which is in networked data communication with a number of MFPs, such as MFP 316 and MFP 320. ECC module 312 communicates software updates to each MFP individually. A failure in ECC module 312 or its ability for data communication prevents distribution. Also, devices that are not compatible with distributed software may inadvertently install it causing damage or device problems. Additionally, there is no mechanism to verify integrity of distributed software. Example embodiments herein employ peer-based MFP software distribution and verification 322 among networked MFPs, such as MFP 324 and MFP 328.

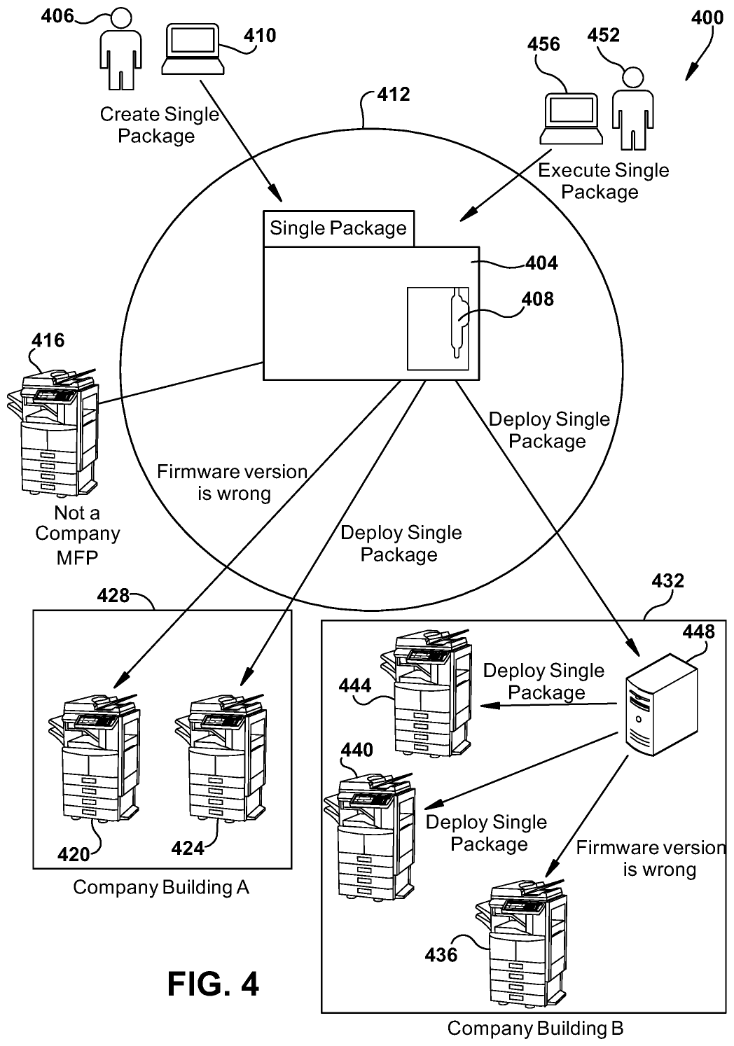

FIG. 4 illustrates an example embodiment of a system 400 for distributing and executing a single package 404, including a smart contract 408 to a plurality of MFPs. Administrator 406 creates and/or distributes single package 404 from workstation 410, and broadcasts it to MFPs in network 412. A single package 404 may be broadcast to MFPs of different manufacture, different configuration, different ownership or different locations. Execution of an associated smart contract suitably limits installation in any or all of these scenarios. In the illustrated example, single package 404 is directed to any MFP owned by “Company” that has a compatible firmware version. No deployment is made to MFP 416 since it is not owned by Company. This is particularly advantage when software in the deployed single package 404 is for a device user interface configuration particular to MFPs owned or leased by Company.

MFPs 420 and 424 are in Company Building A 428, so both are targeted to deploy single package 404. However, MFP 420 has an incompatible firmware version precluding deployment. Company building B 432 includes MFPs 436, 440 and 444. In Building B, deployment of single package 404 is via internal distribution via server 448. Single package 404 is not deployed to MFP 436 as it too has an incompatible firmware version. Once a single package 404 has been deployed in a blockchain block, it is added to the blockchain only at such point that integrity of the associated block has been verified by any suitable distributed verification protocol. Once deployment is completed, installation can be automatically commenced and completed, or completed upon an execution command issued by administrator 452 via workstation 456.

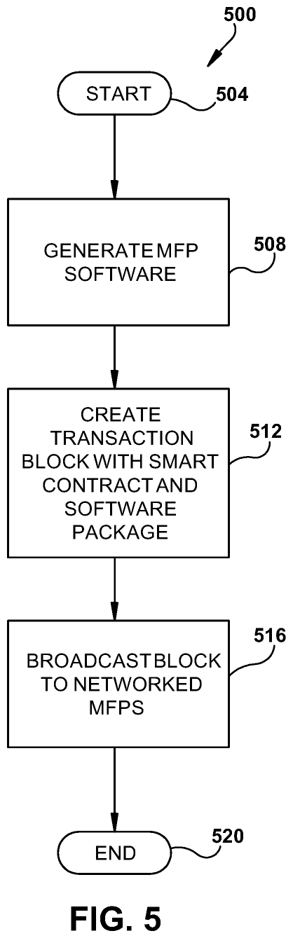

FIG. 5 is a flowchart 500 of an example embodiment of generation and broadcast of software, such as a single package. The process commences at block 504 and proceeds to block 508 wherein software is created or generated. As noted above, any suitable software may be distributed, including device software or updates, including applications operating systems or data files, as well as device configuration, including user interface configuration. A blockchain transaction with software for distribution is created, inclusive of a smart contract, at block 512. The software package block is broadcast to one or more network devices at block 516, and the process ends at block 520.

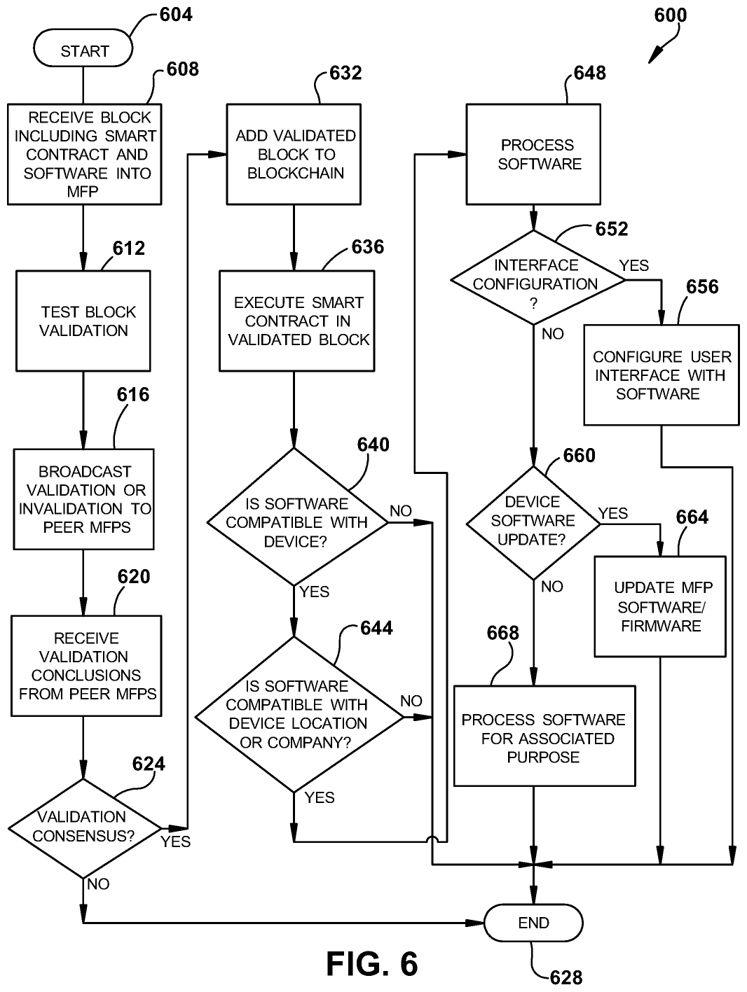

FIG. 6 is a flowchart 600 for operation of devices such as WI's relative to receiving, validating and installing software in accordance with a blockchain. The process commences at block 604 and proceeds to block 608 where a block, including software and a smart contract, is received. A received block is tested to be determined as valid or invalid at block 612, and if verified, such validation is broadcast to peer devices at block 616. Validation is received from peer devices at block 620. A validation consensus is tested at block 624, and if the consensus is that the block is not valid, the process ends at block 628. If there is a consensus of validity, the block is added to the blockchain at block 632, and the smart contract is executed at block 636.

Next, a determination is made as to whether the software is compatible with the device at block 640. If not, the process ends at block 628. If so, a determination is made at block 644 as to whether the software is compatible with a location of a device or ownership or control of the device. If not, the process ends at block 628. If so, the software is set for processing at block 648. If the software is determined to be an interface configuration at block 652, the interface is configured at block 656 and the process ends at block 628. If it is not an interface configuration, a test is made as to whether it is a device software update at block 660. If so, a software update is made at block 664 of device software or firmware, and the process ends at block 628. If not, other software may suitably be processed at block 668, such as changing device settings, updating data, or the like, and the process ends at block 628.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the spirit and scope of the inventions.

What is claimed is:

1. A multifunction peripheral comprising:
a printer;
a scanner;
a user interface;
a processor configured to control operation of the printer and the scanner;
a memory storing a blockchain; and
a network interface configured for data communication with a plurality of networked devices,
wherein the network interface is further configured to receive a block into the memory;
wherein the processor is further configured to validate a received block;
wherein the processor is further configured to receive validation data confirming validation of the received block from the networked devices via the network interface;
wherein the processor is further configured to append the validated block to the blockchain;
wherein the processor is further configured to execute a smart contract encoded into the received block;
wherein the processor is further configured to determine compatibility of software in the validated block with the multifunction peripheral in accordance with an executed smart contract; and
wherein the processor is further configured to process the software when the processor determines it to be compatible with the multifunction peripheral in accordance with execution of the smart contract.

2. The multifunction peripheral of claim 1 wherein the multifunction peripheral includes firmware, and wherein the processor is further configured to determine compatibility of the software in accordance with a version of the firmware.

3. The multifunction peripheral of claim 1 wherein the software is comprised of a preset configuration of the user interface, and wherein the processor is further configured to reconfigure the user interface in accordance with the software.

4. The multifunction peripheral of claim 1 wherein the processor is further configured to isolate a received block until receipt of the validation data.

5. The multifunction peripheral of claim 1 wherein the processor is further configured to determine compatibility of the software in accordance with data corresponding to a location of the multifunction peripheral.

6. The multifunction peripheral of claim 5 wherein the software is specific to a business associated with the location of the multifunction peripheral.

7. The multifunction peripheral of claim 6 wherein the software is comprised a preset configuration of the user interface associated with the business, and wherein the processor is further configured to reconfigure the user interface in accordance with the software.

8. A method comprising:
storing a blockchain in a memory;
communicating data with a plurality of networked devices via a network interface;
receiving a block into the memory via the network interface;
validating a received block;
receiving validation data confirming validation of the received block from the networked devices via the network interface;
appending the validated block to the blockchain;
executing a smart contract encoded into the received block;
determining compatibility of software in the validated block with a multifunction peripheral in accordance with an executed smart contract; and
processing the software when the processor determines it to be compatible with the multifunction peripheral in accordance with execution of the smart contract.

9. The method of claim 8 wherein the multifunction peripheral includes firmware, and further comprising determining compatibility of the software in accordance with a version of the firmware.

10. The method of claim 8 wherein the software is comprised of a preset configuration of the user interface, and further comprising reconfiguring the user interfaces in accordance with the software.

11. The method of claim 8 further comprising isolating a received block until receipt of the validation data.

12. The method of claim 8 further comprising determining compatibility of the software in accordance with data corresponding to a location of the multifunction peripheral.

13. The method of claim 12 wherein the software is specific to a business associated with the location of the multifunction peripheral.

14. The method of claim 13 wherein the software is comprised a preset configuration of the user interface associated with the business, and further comprising reconfiguring the user interfaces in accordance with the software.

15. A method comprising;
configuring a block to include a smart contract and software;
broadcasting a configured block to a plurality of multifunction peripherals;
receiving the configured block at each of the multifunction peripherals;
validating the configured block at each of the multifunction peripherals;
exchanging validation between the multifunction peripherals;
validating the configured block at each of the multifunction peripherals after receipt of validation from other multifunction peripherals;
adding a validated block to a blockchain stored in a memory of each of multifunction peripheral;
executing, at each multifunction peripheral, the smart contract from the validated block;
determining compatibility of the software at each of the multifunction peripherals in accordance with execution of the smart contract; and
selectively processing the software at each of the multifunction peripherals in accordance with determined compatibility.

16. The method of claim 15 further comprising determining the compatibility of the software at each of the multifunction peripherals in accordance with its location.

17. The method of claim 16 further comprising determining the compatibility of the software at each of the multifunction peripherals in accordance with a version of its firmware.

18. The method of claim 17 further comprising configuring, with the software, a user interface of each multifunction peripheral determined to be compatible with the software.

19. The method of claim 18 further comprising determining the compatibility of the software at each multifunction peripheral location in accordance with a business associated with its location.

20. The method of claim 17 wherein the software is comprised of a multifunction peripheral software or firmware update.
